(19) United States
(12) Patent Application Publication
(10) Pub. No.: US 2021/0311978 A1
(43) Pub. Date: Oct. 7, 2021

(54) COMPUTER-READABLE RECORDING MEDIUM STORING MANAGEMENT PROGRAM, MANAGEMENT METHOD, AND INFORMATION PROCESSING DEVICE

(71) Applicant: FUJITSU LIMITED, Kawasaki-shi (JP)

(72) Inventors: Shinichi KAWAKAMI, Chiba (JP); Masaki OHASHI, Kawasaki (JP); Miyuki YAMADA, Shinagawa (JP)

(73) Assignee: FUJITSU LIMITED, Kawasaki-shi (JP)

(21) Appl. No.: 17/348,997

(22) Filed: Jun. 16, 2021

Related U.S. Application Data
(63) Continuation of application No. PCT/JP2019/001446, filed on Jan. 18, 2019.

(51) Int. Cl. G06F 16/332; G06F 16/33; G06F 16/36; G06F 16/35

(52) U.S. Cl. CPC G06F 16/3329; G06F 16/358; G06F 16/36; G06F 16/3344

(57) ABSTRACT

A non-transitory computer-readable recording medium stores a management program for causing a computer to execute processing including: receiving a registration request for a question text; searching for another question text similar to the question text for which the registration request has been received by reference to a storage unit that stores a plurality of pieces of registration information that includes a question text and an answer text to the question text; and displaying, in a receivable manner, an editing request for the registration information that corresponds to the another question text together with the another question text in a case where the another question text has been searched.

### CROSS-REFERENCE TO RELATED APPLICATION

This application is a continuation application of International Application PCT/JP2019/001446 filed on Jan. 18, 2019 and designated the U.S., the entire contents of which are incorporated herein by reference.

### FIELD

The embodiment discussed herein is related to a management program, a management method and a management device.

### BACKGROUND

Typically, there have been used manned systems such as call centers that receive and respond to question texts from end users of mail order, online sales, online games, and the like and question texts from administrators regarding system failures or the like, by telephone, e-mail, or the like. In recent years, there has been known a chat-format frequently asked questions (FAQ) system by a computer that enables responding to a question text from an end user, an administrator, or the like even in hours other than manned business hours.

International Publication Pamphlet No. WO 2006/085661 and Japanese Laid-open Patent Publication No. 2008-251051 are disclosed as related art.

### SUMMARY

According to an aspect of the embodiments, a non-transitory computer-readable recording medium stores a management program for causing a computer to execute processing including: receiving a registration request for a question text; searching for another question text similar to the question text for which the registration request has been received by reference to a storage unit that stores a plurality of pieces of registration information that includes a question text and an answer text to the question text; and displaying, in a receivable manner, an editing request for the registration information that corresponds to the another question text together with the another question text in a case where the another question text has been searched.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a frequently asked questions (FAQ) system according to a first embodiment;

FIG. 2 is a diagram for describing communication of the FAQ system;

FIG. 3 is a diagram illustrating an example of an FAQ maintenance screen displayed on an administrator terminal;

FIG. 4 is a diagram illustrating an example of the FAQ maintenance screen displayed on the administrator terminal;

FIG. 5 is a diagram illustrating an example of the FAQ maintenance screen displayed on the administrator terminal;

FIG. 6 is a diagram illustrating an example of the FAQ maintenance screen displayed on the administrator terminal;

FIG. 7 is a diagram illustrating an example of a chatbot screen displayed on a user terminal;

FIG. 8 is a diagram illustrating an example of the chatbot screen displayed on the user terminal;

FIG. 9 is a functional block diagram illustrating a functional configuration of a management device according to the first embodiment;

FIG. 10 is a diagram illustrating an example of a data configuration of a FAQ list;

FIG. 11 is a flowchart illustrating a flow of management processing according to the first embodiment; and

FIG. 12 is a diagram for describing a hardware configuration example.

### DESCRIPTION OF EMBODIMENTS

When receiving a question text from a user via a chat, the FAQ system acquires an answer text corresponding to the question text from an FAQ list database (DB) and provides the answer text to the user. The FAQ list DB registers a FAQ in which a question text and a corresponding answer text are associated with each other.

Here, when an FAQ administrator newly registers a FAQ, there is a case where a question text similar to the question text to be registered has already been registered in another FAQ. If a different FAQ is newly registered in the state where the similar question text is registered in the another FAQ, the another FAQ that has been hit so far may be no longer hit. Furthermore, in this case, since a large number of answers are given to the user's question, the user needs to perform an operation of narrowing down the answers.

One aspect is intended to provide a management program, a management method, and a management device capable of providing an appropriate answer to a question from a user.

Hereinafter, an embodiment of a management program, a management method, and a management device will be described in detail with reference to the drawings. Note that an embodiment is not limited to the present embodiment. Furthermore, each of the embodiments may be appropriately combined within a range without inconsistency.

### First Embodiment

[Overall Configuration]

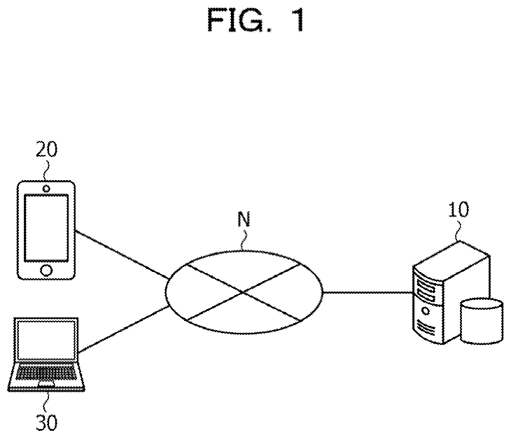

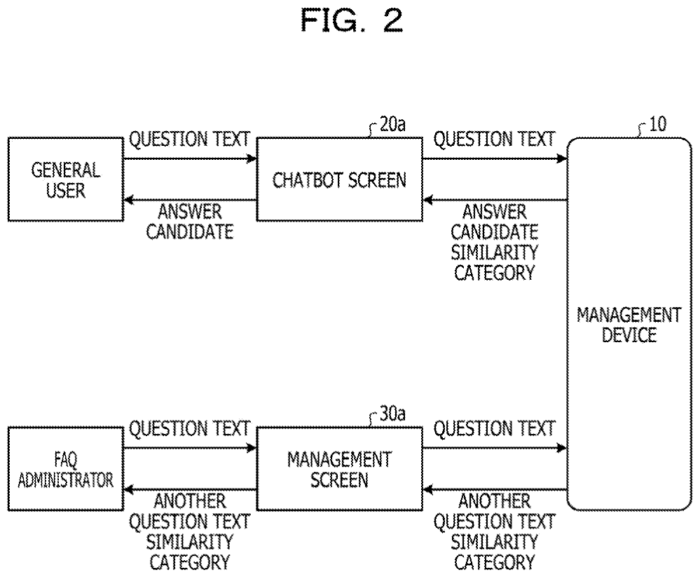

FIG. 1 is a diagram for describing a frequently asked questions (FAQ) system according to a first embodiment. FIG. 2 is a diagram for describing communication of the FAQ system.

As illustrated in FIG. 1, the FAQ system is a system in which a management device 10, a user terminal 20, and an administrator terminal 30 are connected via a network N. This FAQ system is a system in which the management device 10 receives a question text from the user terminal 20 in a chat format and responds to the user terminal 20 with an answer to the question text. Note that examples of the question text include a question from an end user of a mail order, an online sale, an online game, or the like, a question from an administrator regarding, for example, a system failure, or the like. Furthermore, as the network N, various communication networks such as the Internet or a dedicated line can be adopted regardless of whether the network is wired or wireless.

The user terminal 20 is an example of a computer device used by a general user, and is, for example, a smartphone or the like. This user terminal 20 accesses the management device 10, and inputs the question text and acquires an answer, using a Web browser or a dedicated application.

The administrator terminal 30 is an example of a computer device used by an FAQ administrator, and is, for example, a personal computer or the like. The administrator terminal 30 accesses the management device 10 using a Web browser or a dedicated application, and performs processing such as FAQ editing

The management device 10 is an example of a computer device that answers the question text input from a general user via the user terminal 20. When receiving an access from the user terminal 20, the management device 10 displays a chatbot screen, which is an example of a chat-format Web screen, on the user terminal 20. As illustrated in FIG. 2, when receiving the question text from the user terminal 20 on the chatbot screen 20a, the management device 10 searches a DB for answer candidates corresponding to the question text. The management device 10 outputs the searched answer candidates on the chatbot screen 20a after sorting the answer candidates by similarity or narrowing down the answer candidates by category so that the answer candidates can be easily checked on the chatbot screen 20a. In this way, the management device 10 can provide an environment in which an answer to the question text can be made at any timing of the user regardless of business hours or the like.

Furthermore, the management device 10 receives FAQ maintenance processing by the FAQ administrator via the administrator terminal 30 and performs FAQ management. When receiving an access from the administrator terminal 30, the management device 10 displays a management screen 30a for FAQ maintenance on the administrator terminal 30.

When receiving a registration request for the question text from the FAQ administrator on the management screen 30a, the management device 10 searches a DB for another question text similar to the question text for which the registration request has been received. The management device 10 displays an editing request for an FAQ corresponding to the another question text in a receivable manner together with the searched another question text on the management screen 30a. In this case, the management device 10 displays the similarity to the question text for which the registration request has been received and a category to which the another question text belongs together with the searched another question text. In this way, the management device 10 can provide the FAQ administrator with an environment in which FAQ maintenance is possible.

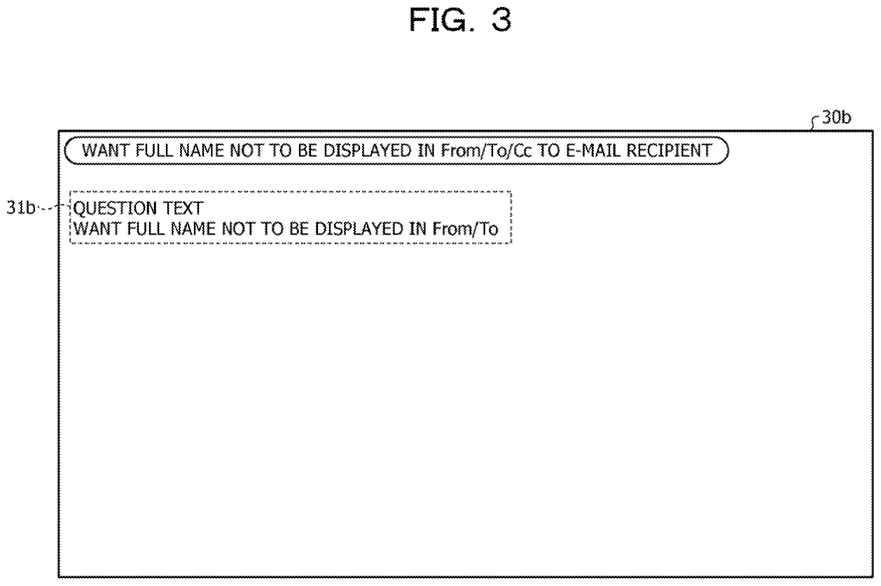

FIGS. 3 to 6 are diagrams illustrating examples of an FAQ maintenance screen displayed on the administrator terminal 30. For example, as illustrated in FIG. 3, the management device 10 receives a registration request for a question text “want a full name not to be displayed in From/To” (see a registration request field 31b) on an FAQ maintenance screen 30b from the FAQ administrator.

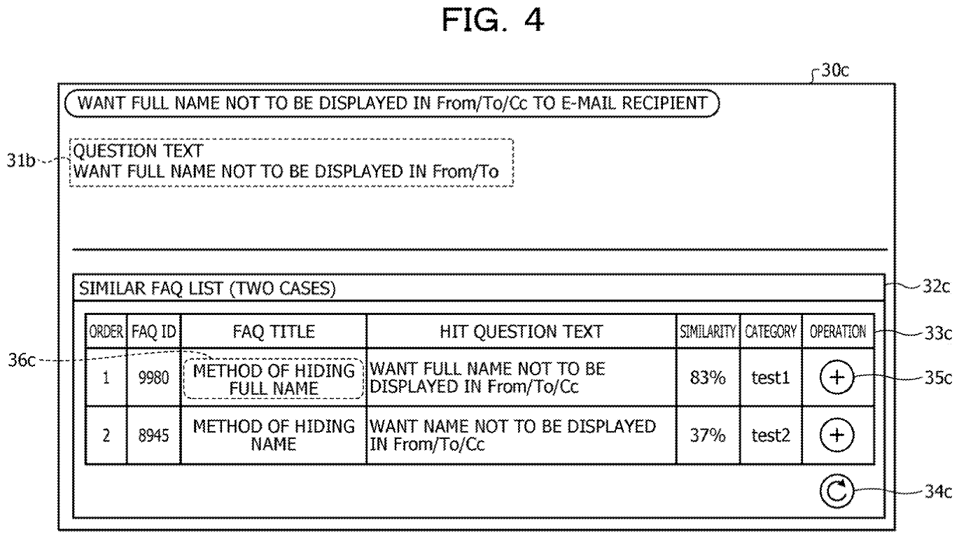

Next, the management device 10 refers to the DB and searches for other question texts “want a full name not to be displayed in From/To/Cc” and “want a name not to be displayed in From/To/Cc” similar to the question text “want a full name not to be displayed in From/To” for which the registration request has been received. The management device 10 displays the editing requests for the FAQs of the searched “want a full name not to be displayed in From/To/Cc” and “want a name not to be displayed in From/To/a” in a receivable manner, as illustrated in the FAQ maintenance screen 30c in FIG. 4.

This FAQ maintenance screen 30c is provided with a similar FAQ list 32c having an order, an FAQ ID, an FAQ title, a hit question text, the similarity, the category, and an operation field. The management device 10 displays the searched question texts “want a full name not to be displayed in From/To/Cc” and “want a name not to be displayed in From/To/Cc” in the hit question text field in descending order of similarity. The management device 10 displays a title of the FAQ to which the searched question text belongs in the FAQ title field.

The management device 10 displays the similarity between the searched question text and the question text for which the registration request has been received as a percentage in the similarity field in the similar FAQ list 32c. The management device 10 displays each category to which the searched question text belongs in the category field in the similar FAQ list 32c.

In this way, the management device 10 displays the similar FAQ list 32c capable of receiving the editing request for the FAQ corresponding to other question texts similar to the question text for which the registration request has been received together with the other question texts on the administrator terminal 30. The FAQ administrator can check whether a question text similar to the question text to be registered is registered in another FAQ according to the similar FAQ list 32c. In this case, the FAQ administrator can also check the similarity and a difference in category between the question text to be registered and the similar question text according to the similar FAQ list 32c. Therefore, the FAQ administrator can appropriately consider whether to register the question text to be registered in a different FAQ. Therefore, according to the management device 10, newly registering a different FAQ in the state where the similar question text is registered in another FAQ can be avoided.

Furthermore, an update button 34c is provided in the similar FAQ list 32c. When the FAQ administrator selects the update button 34c after changing the question text in the registration request field 31b, the similar FAQ list 32c is updated according to the changed question text. In this case, the management device 10 searches again for another question text similar to the changed question text and redisplays the searched another question text in the similar FAQ list 32c. The FAQ administrator can also edit the question text to be registered that the FAQ administrator itself has input. Then, the management device 10 updates and displays the similar FAQ list 32c for the edited question text Therefore, the FAQ administrator can quickly grasp the presence or absence of other question texts similar to the edited question text by checking the updated similar FAQ list 32c.

Furthermore, the FAQ administrator can transition to an FAQ editing screen on which the FAQ can be edited by clicking each FAQ title in the similar FAQ list 32c. For example, the FAQ administrator selects a “method of hiding a full name” (see the field 36c) from each FAQ title in the similar FAQ list 32c. In this case, the management device 10 displays the FAQ editing screen on which a question text or the like of the selected FAQ “method of hiding a full name” can be edited on the administrator terminal 30. In this way, according to the management device 10, the FAQ administrator can also edit the question text of the already registered FAQ.

Then, an addition button 35c is displayed in the operation field 33c in the similar FAQ list 32c. When the FAQ administrator clicks the addition button 35c of the question text in the order “1” row, the question text in the registration request field 31b can be added to the FAQ of this row,

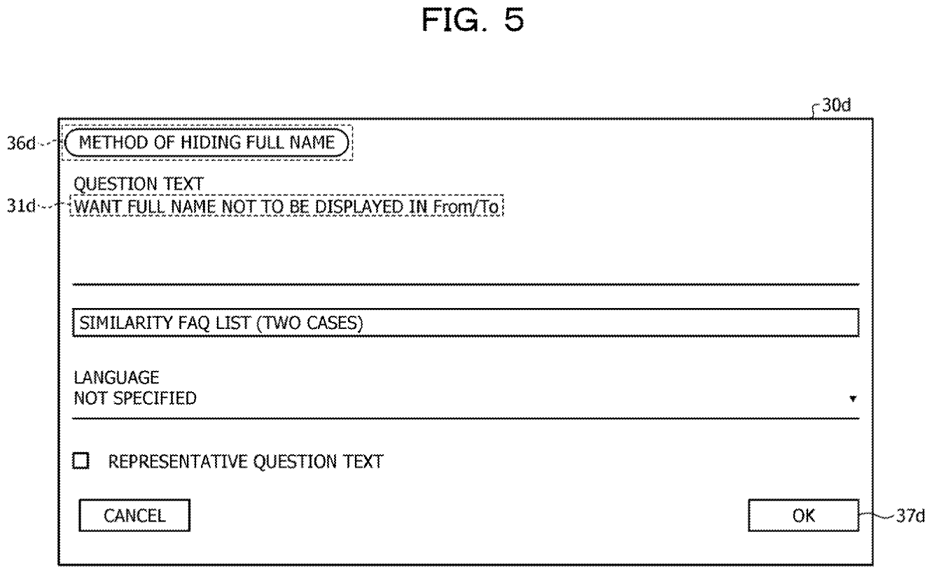

Specifically, when the addition button 35c of the question text in the order “1” row is clicked, the management device 10 displays a question text registration screen 30d (see FIG. 5) for the FAQ “method of hiding a full name” in the clicked row on the administrator terminal 30. This question text registration screen 30d displays the selected FAQ “method of hiding a full name” in an FAQ field 36d and transcribes the question text to be registered, which has been input on the FAQ maintenance screen 30b, in a registration request field 31d. Then, the question text registration screen 30d displays, at lower right, an OK button 37d that instructs addition of the question text in the registration request field 31d to the FAQ in the FAQ field 36d.

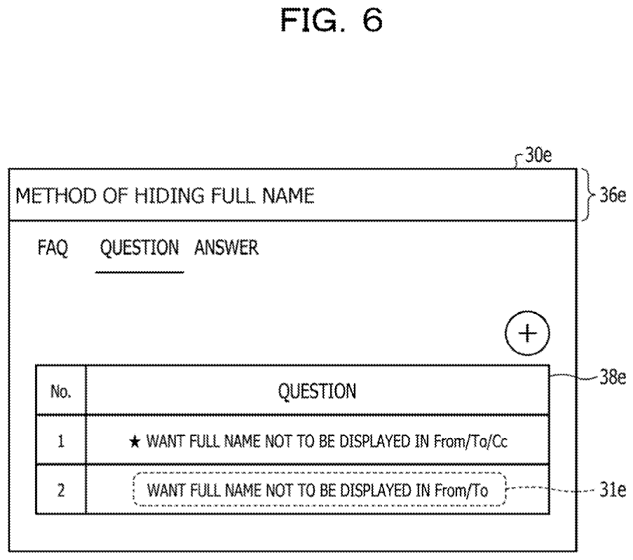

When the FAQ administrator clicks the OK button 37d, the management device 10 additionally registers the question text “want a full name not to be displayed in From/To” in the registration request field 31d to the FAQ “method of hiding a full name” in the FAQ field 36d. Then, the management device 10 displays a question text list screen 30e of the FAQ “method of hiding a full name” illustrated in FIG. 6 on the administrator terminal 30. The question text list screen 30e displays a list 38e of question texts corresponding to the FAQ “method of hiding a full name” in an FAQ field 36e. The list 38e of question texts indicates that the question texts of the FAQ “method of hiding a full name” are the “want a full name not to be displayed in From/To/Cc” and the “want a full name not to be displayed in From/To” to be registered (see the field 31e).

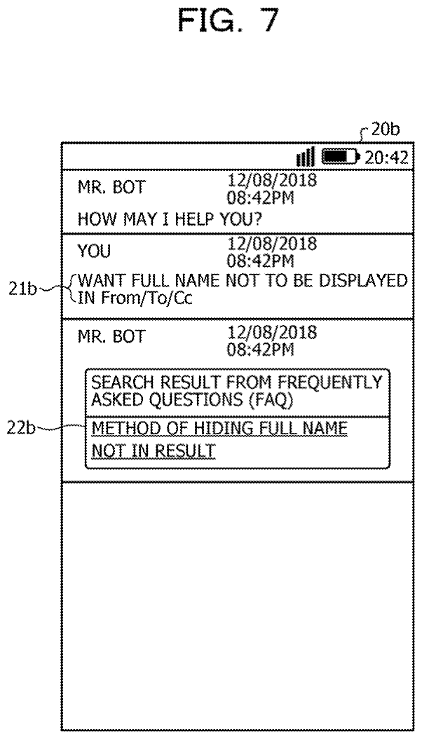

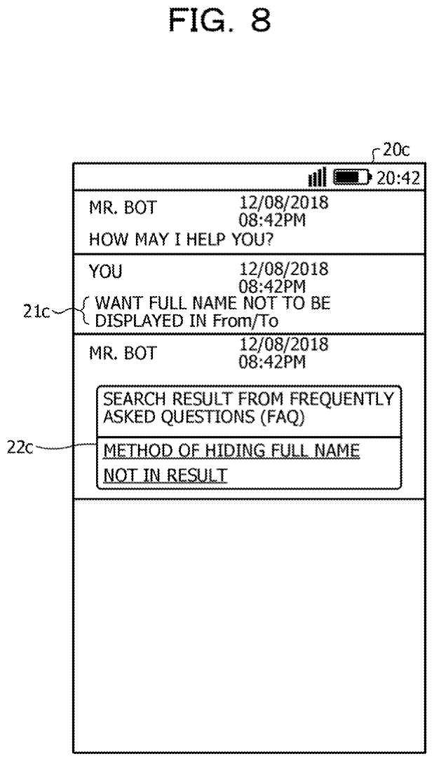

In this way, in the case where a question similar to the question to be registered is already in an FAQ, the management device 10 displays the editing screen on which the question to be registered can be added to the FAQ and associates a plurality of questions having different wordings with one answer, thereby increasing a chatbot hit rate. Specific description will be given with reference to FIGS. 7 and 8. FIGS. 7 and 8 are diagrams illustrating examples of the chatbot screen displayed on the user terminal 20.

A case in which a general user has input the question text “want a full name not to be displayed in From/To/Cc” (question text 1) or “want a full name not to be displayed in From/To” (question text 2) to a question field 21b or 21c of a chatbot screen 20b or 20c will be described. In the case where the question text 1 is input, the management device 10 displays the FAQ “method of hiding a full name” corresponding to the question text 1 in an answer field 22b. Furthermore, in the case where the question text 2 is input, the management device 10 displays the FAQ “method of hiding a full name” corresponding to the question text 2 in an answer field 22c.

So far, there are some cases where if a different FAQ is newly registered in the state where the similar question text is registered in the another FAQ, the another FAQ that has been hit so far may be no longer hit. To cope with the cases, the management device 10 enables registration by associating a plurality of questions having different wordings with one answer. Therefore, the management device 10 can appropriately provide an answer even when question texts having different wordings are input to the same answer, such as the question texts 1 and 2. That is, the management device 10 can maintain the hit of the FAQ “method of hiding a full name” for the previously registered question text 1. Then, since the management device 10 provides the answer “method of hiding a full name” to the newly added question text 2, the user does not have to perform an operation of narrowing down a plurality of answers.

[Configuration of Management Device]

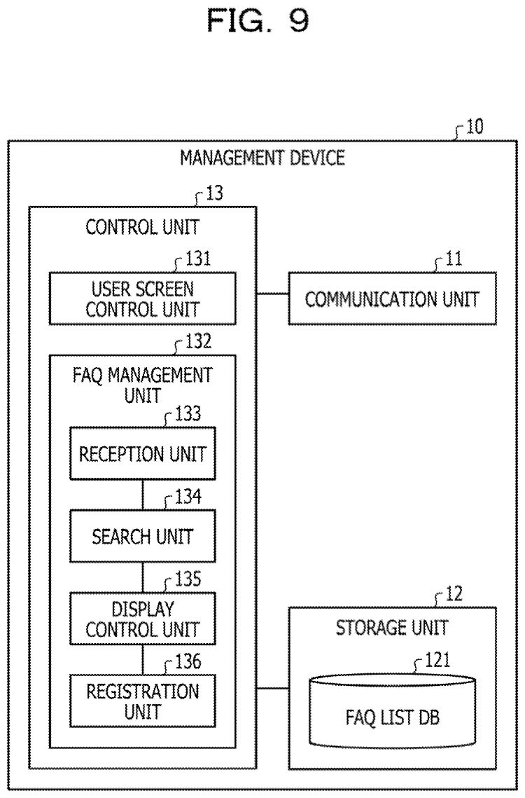

Next, a configuration of the management device 10 illustrated in FIG. 1 will be described. FIG. 9 is a functional block diagram illustrating a functional configuration of the management device 10 according to the first embodiment. As illustrated in FIG. 9, the management device 10 includes a communication unit 11, a storage unit 12, and a control unit 13.

The communication unit 11 is a processing unit that controls communication with the user terminal 20 or the administrator terminal 30 and is, for example, a communication interface or the like. For example, the communication unit 11 establishes communication with the user terminal 20 or the administrator terminal 30, and transmits and receives data.

The storage unit 12 is an example of a storage device that stores programs and data and is, for example, a memory, a hard disk, and the like. This storage unit 12 stores an FAQ list DB 121.

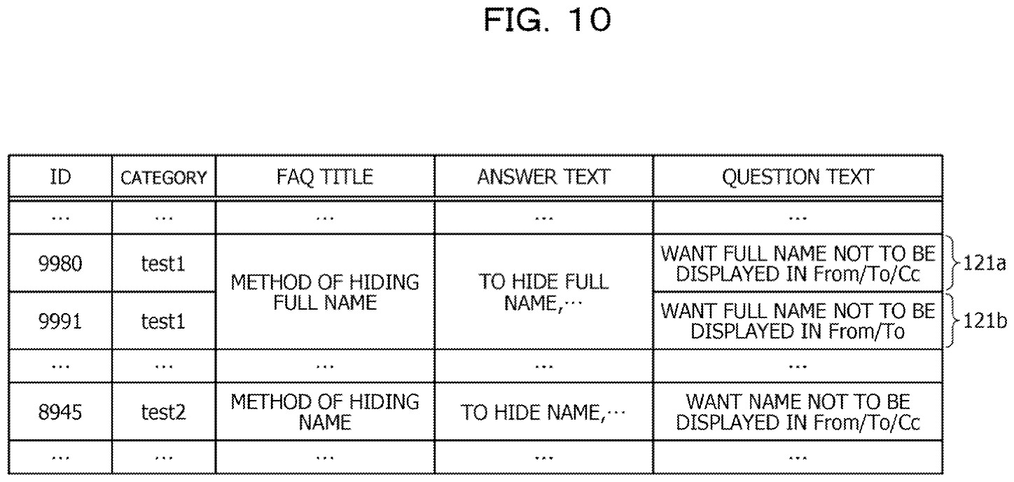

The FAQ list DB 121 stores an FAQ list. The FAQ list has information of a plurality of FAQs. The FAQ is registration information including a question text and an answer text to the question text FIG. 10 is a diagram illustrating an example of a data configuration of the FAQ list. As illustrated in FIG. 10, the FAQ list has items of “ID”, “category”, “FAQ title”, “question text”, and “answer text”. The “ID” is an identifier used to identify an FAQ. The “Category” indicates a category to which the FAQ belongs. The “FAQ title” indicates a title of the FAQ. The “question text” is content of the question text by a questioner. The “answer text” indicates content of the answer to the question text

In the example in FIG. 10, the FAQ with the ID “9980” belongs to the category “test1” and the FAQ title is the “method of hiding a full name” (see the row R121a). In the FAQ with the ID “9980”, the question text “want a full name not to be displayed in From/To/Cc” and the answer text “To hide a full name, . . . ” are associated with each other. Then, the FAQ with the ID “9991” belongs to the same category and has the same FAQ title and answer text as the FAQ with the ID “9980”, and the question text is “want a full name not to be displayed in From/To” (see the row R121b). In this way, the FAQ list DB 121 stores the plurality of questions having different wordings in association with one answer.

The control unit 13 is a processing unit that controls the entire management device 10 and is, for example, a processor or the like. The control unit 13 includes a user screen control unit 131 and an FAQ management unit 132. Note that the user screen control unit 131 and the FAQ management unit 132 are examples of an electronic circuit such as a processor or examples of a process executed by the processor,

The user screen control unit 131 is a processing unit that executes control of the chatbot screen with the user terminal 20. For example, when receiving an access to the FAQ system from the user terminal 20, the user screen control unit 131 transmits the chatbot screen to the user terminal 20. Then, the user screen control unit 131 executes reception of a question text or the like and output of an answer or the like on the chatbot screen.

The FAQ management unit 132 is a processing unit that executes control of the FAQ maintenance screen and registers the FAQ list of the FAQ list DB 121 with the administrator terminal 30. When receiving an access to the FAQ system from the administrator terminal 30, the FAQ management unit 132 transmits the FAQ maintenance screen to the administrator terminal 30. Then, the FAQ management unit 132 receives the registration request for the question text and the FAQ editing request on the FAQ maintenance screen, and registers the FAQ list DB 121 according to the received content. The FAQ management unit 132 includes a reception unit 133, a search unit 134, a display control unit 135, and a registration unit 136.

The reception unit 133 receives the registration request for the question text on the FAQ maintenance screen of the administrator terminal 30. Furthermore, the reception unit 133 receives an addition request for the question text for which the registration request has been received to the FAQ corresponding to another question text similar to the question text for which the registration request has been received on the FAQ maintenance screen.

The search unit 134 refers to the FAQ list DB 121 and searches for another question text similar to the question text for which the registration request has been received. For example, the search unit 134 acquires the question text similar to the question text for which the registration request has been received by comparing tfidf patterns of the question text for which the registration request has been received and the question text to be compared.

In a case where another question text has been searched by the search unit 134, the display control unit 135 displays the editing request for the FAQ corresponding to the another question text in a receivable manner together with the another question text on the FAQ maintenance screen of the administrator terminal 30. In this case, the display control unit 135 displays the category to which the another question text belongs in association with the another question text on the FAQ maintenance screen,

The registration unit 136 registers information in the FAQ list DB 121 according to a registration instruction received on the FAQ maintenance screen. For example, when receiving editing of the question text of the registered FAQ on the FAQ editing screen, the registration unit 136 edits the question text registered in the FAQ list DB 121 according to editing content.

Furthermore, when receiving the addition request for the question text for which the registration request has been received to the FAQ corresponding to the another question text similar to the question text for which the registration request has been received on the FAQ maintenance screen, the registration unit 136 adds the question text for which the registration request has been received to the FAQ corresponding to the another question text.

[Flow of Processing]

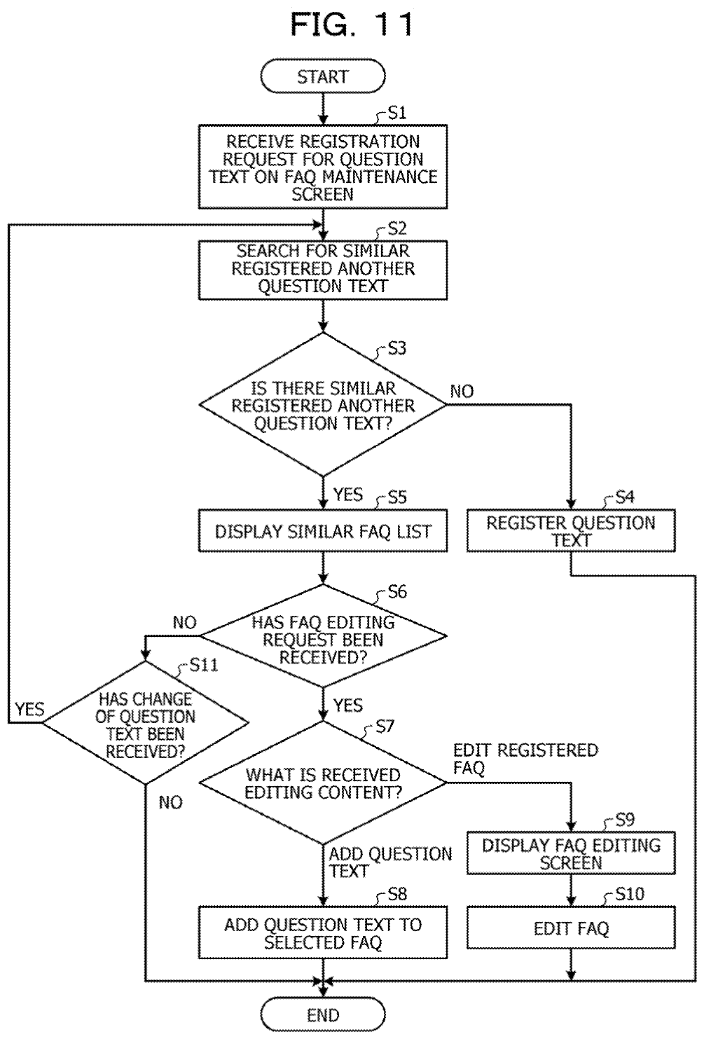

FIG. 11 is a flowchart illustrating a flow of management processing according to the first embodiment In FIG. 11, an example of a flow of processing after the management device 10 receives the access from the administrator terminal 30 by the FAQ administrator and displays the FAQ maintenance screen on the administrator terminal 30 will be described.

As illustrated in FIG. 11, the reception unit 133 of the management device 10 receives the registration request of the question text on the FAQ maintenance screen from the administrator terminal 30 (step S1). The search unit 134 refers to the FAQ list DB 121 and searches for another question text similar to the question text for which the registration request has been received (step S2). The FAQ management unit 132 determines whether there is similar registered another question text (step S3).

In a case where the FAQ management unit 132 determines that there is no similar registered another question text (step S3: No), the FAQ management unit 132 registers a new FAQ for the question text for which the registration request has been received (step S4) and terminates FAQ editing for the question text to be registered.

Meanwhile, a case where the FAQ management unit 132 determines that there is similar registered another question text (step S3: Yes) will be described. In this case, the display control unit 135 displays a similar FAQ list capable of receiving an editing request for the FAQ corresponding to the another question text on the FAQ maintenance screen of the administrator terminal 30 (step S5). Then, the FAQ management unit 132 determines whether FAQ editing has been received by the reception unit 133 (step S6).

In a case where the FAQ management unit 132 determines that the FAQ editing has been received by the reception unit 133 (step S6: Yes), the FAQ management unit 132 determines whether the received editing content is addition of the question text for which the registration request has been received or editing of the registered FAQ (step S7).

In a case where the editing content received by the FAQ management unit 132 is addition of the question text for which the registration request has been received (step S7: question text addition), the registration unit 136 adds the question text for which the registration request has been received to the selected FAQ (step S8). Then, the FAQ management unit 132 terminates the editing the FAQ for the question text to be registered.

In a case where the editing content received by the FAQ management unit 132 is editing of the registered FAQ (step S7: editing of registered FAQ), the display control unit 135 displays the FAQ editing screen for the registered FAQ on the administrator terminal 30 (step S9). Then, the registration unit 136 edits the question text and the like registered in the FAQ list DB 121 according to the editing content received on the FAQ editing screen (step S10), and terminates the FAQ editing for the question text to be registered.

Furthermore, in a case where the FAQ management unit 132 determines that the FAQ editing has not been received by the reception unit 133 (step S6: No), the FAQ management unit 132 determines whether a change of the question text to be registered has been received (step S11). In a case where the FAQ management unit 132 determines that the change of the question text to be registered has been received (step S11; Yes), the FAQ management unit 132 proceeds to step S2 and searches for registered another question text similar to the changed question text. On the other hand, in a case where the FAQ management unit 132 determines that the change of the question text to be registered has not been received (step S11: No), the FAQ management unit 132 terminates the FAQ editing for the question text to be registered.

[Effects]

In this way, the management device 10 displays, in a receivable manner, the editing request for the FAQ corresponding to other question texts similar to the question text for which the registration request has been received together with the other question texts on the administrator terminal 30. Thereby, the FAQ administrator can edit the FAQ after confirming whether a question text similar to the question text to be registered is registered in another FAQ, and can avoid new registration of a different FAQ in the state where the similar question text is registered in another FAQ.

Then, since the management device 10 displays the category to which the another question text belongs when displaying the editing request for the FAQ corresponding to the another question text in a receivable manner on the administrator terminal 30, the FAQ administrator can also confirm the difference in category from the question text similar to the question text to be registered.

Furthermore, in the case where the question text similar to the question text to be registered is already in an FAQ, the management device 10 displays the editing screen on which the question text to be registered can be added to the FAQ and associates a plurality of question texts having different wordings with one answer text, thereby increasing the chatbot hit rate. In other words, the management device 10 absorbs fluctuations in the expression of the question text by the user by associating the plurality of question texts having different wordings with the same answer, and provides an appropriate number of answers.

As described above, according to the first embodiment, an appropriate answer to the question from the user can be provided.

[System]

Pieces of information including a processing procedure, a control procedure, a specific name, various types of data, and parameters described above in the above document or illustrated in the drawings may be changed in any ways unless otherwise specified. Furthermore, the specific examples, distributions, numerical values, and the like described in the embodiments are merely examples, and may be changed in any ways.

In addition, each component of each device illustrated in the drawings is functionally conceptual and does not necessarily have to be physically configured as illustrated in the drawings. In other words, for example, specific forms of distribution and integration of each device are not limited to those illustrated in the drawings. That is, for example, all or a part of the device may be configured by being functionally or physically distributed or integrated in optional units according to various types of loads, usage situations, or the like. Moreover, all or any part of individual processing functions performed by each device may be implemented by a central processing unit (CPU) and a program analyzed and executed by the CPU, or may be implemented as hardware by wired logic.

[Hardware]

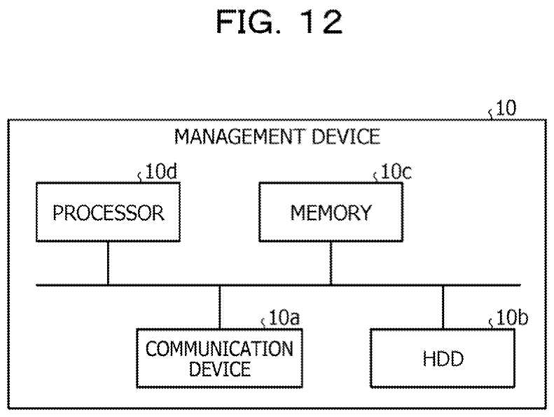

FIG. 12 is a diagram for explaining a hardware configuration example. As illustrated in FIG. 12, the management device 10 includes a communication device 10a, a hard disk drive (HDD) 10b, a memory 10c, and a processor 10d. Furthermore, each of the units illustrated in FIG. 12 is mutually connected by a bus or the like.

The communication device 10a is a network interface card or the like and communicates with another server. The HDD 10b stores a program that activates the functions illustrated in FIG. 6, and a DB.

The processor 10d reads a program that executes processing similar to the processing of each processing unit illustrated in FIG. 9 from the HDD 10b or the like, and develops the read program in the memory 10c, thereby activating a process that performs each function described with reference to FIG. 6 or the like. In other words, this process executes a function similar to the function of each processing unit included in the management device 10. Specifically, for example, the processor 10d reads a program having functions similar to the screen control unit 15, the acquisition unit 16, the determination unit 17, or the like from the HDD 10b or the like. Then, the processor 10d executes a process for executing processing similar to the user screen control unit 131, the FAQ management unit 132, or the like.

As described above, the management device 10 operates as an information processing device that executes an answering method by reading and executing a program. Furthermore, the management device 10 may also implement functions similar to the above-described embodiments by reading the above-described program from a recording medium by a medium reading device and executing the read program. Note that the program referred to in other embodiment is not limited to being executed by the management device 10. For example, the present embodiment may be similarly applied to a case where another computer or server executes the program, or a case where such a computer and a server execute the program in cooperation.

This program may be distributed via a network such as the Internet. Furthermore, this program is recorded on a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a management program for causing a computer to execute processing comprising:
receiving a registration request for a question text;
searching for another question text similar to the question text for which the registration request has been received by reference to a storage unit that stores a plurality of pieces of registration information that includes a question text and an answer text to the question text; and
displaying, in a receivable manner, an editing request for the registration information that corresponds to the another question text together with the another question text in a case where the another question text has been searched.

2. The non-transitory computer-readable recording medium storing a management program according to claim 1, wherein
the registration information includes category information that indicates a category to which the question text and the answer text belong, and
the processing of displaying includes displaying a category to which the another question text belongs in association with the another question text.

3. The non-transitory computer-readable recording medium storing a management program according to claim 1 for causing the computer to further execute processing comprising:
receiving an addition request for the question text for which the registration request has been received, to the registration information that corresponds to the another question text; and
adding the question text for which the registration request has been received to the registration information that corresponds to the another question text.

4. A management method comprising:
receiving, by a computer, a registration request for a question text;
searching for another question text similar to the question text for which the registration request has been received by reference to a storage unit that stores a plurality of pieces of registration information that includes a question text and an answer text to the question text; and
displaying, in a receivable manner, an editing request for the registration information that corresponds to the another question text together with the another question text in a case where the another question text has been searched.

5. The management method according to claim 4, wherein
the registration information includes category information that indicates a category to which the question text and the answer text belong, and
the processing of displaying includes displaying a category to which the another question text belongs in association with the another question text.

6. The management method according to claim 4 further comprising:
receiving an addition request for the question text for which the registration request has been received, to the registration information that corresponds to the another question text; and
adding the question text for which the registration request has been received to the registration information that corresponds to the another question text.

7. An information processing device comprising:
a memory; and
a processor coupled to the memory and configured to:
receive a registration request for a question text;
search for another question text similar to the question text for which the registration request has been received by reference to a storage unit that stores a plurality of pieces of registration information that includes a question text and an answer text to the question text; and
display, in a receivable manner, an editing request for the registration information that corresponds to the another question text together with the another question text in a case where the another question text has been searched.

8. The information processing device according to claim 7, wherein
the registration information includes category information that indicates a category to which the question text and the answer text belong, and
the processing of displaying includes displaying a category to which the another question text belongs in association with the another question text.

9. The information processing device according to claim 7, wherein the processor is configured to:
receive an addition request for the question text for which the registration request has been received, to the registration information that corresponds to the another question text; and
add the question text for which the registration request has been received to the registration information that corresponds to the another question text.
